(19) United States
(12) Patent Application Publication
(10) Pub. No.: US 2023/0031449 A1
(43) Pub. Date: Feb. 2, 2023

(54) SYSTEM AND METHOD FOR COMPREHENSION BASED QUESTION ANSWERING USING TAXONOMY

(71) Applicant: SRI International, Menlo Park, CA (US)

(72) Inventors: Ajay DIVAKARAN, Monmouth Junction, NJ (US); Michael A. COGSWELL, West Windsor, NJ (US); Pritish SAHU, Piscataway, NJ (US)

(21) Appl. No.: 17/869,589

(22) Filed: Jul. 20, 2022

Related U.S. Application Data
(60) Provisional application No. 63/227,698, filed on Jul. 30, 2021.

(51) Int. Cl. G06N 5/04

(52) U.S. Cl. CPC G06N 5/04

(57) ABSTRACT

A method, apparatus and system for comprehension-based question answering using a hierarchical taxonomy include receiving a word-based question, associating the word-based question with a layer of the hierarchical taxonomy, in which the hierarchical taxonomy includes at least two layers, each of the at least two layers including respective words resulting in the at least two layers having varying levels complexity, determining which layer of the at least two layers of the hierarchical taxonomy comprises a layer of complexity one level less than the layer of the hierarchical taxonomy associated with the word-based question, and using a pre-trained language model, answering the word-based question using only words associated with the layer of the at least two layers of the hierarchical taxonomy having the one less level of complexity.

### CROSS-REFERENCE TO RELATED APPLICATIONS

This application claims benefit of and priority to U.S. Provisional Patent Application Ser. No. 63/227,698, filed Jul. 30, 2021, which is herein incorporated by reference in its entirety.

### FIELD

Embodiments of the present principles generally relate to a method, apparatus and system for comprehension-based question answering and, more particularly, to a method, apparatus and system for comprehension-based question answering implementing a hierarchical knowledge taxonomy.

### BACKGROUND

Content understanding today consists of implementing language models to answer questions about/using the content. Recent large language models such as GPT-3 are able to generalize knowledge obtained from content to new tasks, however for narrow tasks, fail to truly understand the content. That is, for specific tasks, state of the art language models are functionally “stochastic parrots” or “smart/super parrots” that simply memorize without deeper comprehension. That is, current pre-trained language models have lots of knowledge, but a more limited ability to use that knowledge.

### SUMMARY

Embodiments of methods, apparatuses and systems for comprehension-based question answering using a hierarchical taxonomy are disclosed herein.

In some embodiments, a method for comprehension-based question answering using a hierarchical taxonomy includes receiving a word-based question, selecting at least one layer of the hierarchical taxonomy, wherein the hierarchical taxonomy comprises at least two layers, each of the at least two layers including respective words resulting in the at least two layers having varying levels complexity, and using a pre-trained language model, responding to the word-based question using only words associated with the selected at least one layer of the at least two layers of the hierarchical taxonomy.

In some embodiments the method further includes after receiving the word-based question, associating the word-based question with a layer of the hierarchical taxonomy, where the selecting at least one layer of the hierarchical taxonomy includes determining which layer of the at least two layers of the hierarchical taxonomy comprises a layer of complexity one level less than the layer of the hierarchical taxonomy associated with the word-based question, and where the word-based question is responded to by the pre-trained language model using only words associated with the layer of the at least two layers of the hierarchical taxonomy having the one less level of complexity.

In some embodiments, another method for comprehension-based question answering using a hierarchical taxonomy includes receiving a word-based question, associating the word-based question with a layer of the hierarchical taxonomy, wherein the hierarchical taxonomy comprises at least two layers, each of the at least two layers including respective words resulting in the at least two layers having varying levels complexity, determining a layer of the at least two layers of the hierarchical taxonomy which comprises a layer of complexity one level less than the layer of the hierarchical taxonomy associated with the word-based question, using a pre-trained language model, responding to the word-based question by using only words associated with the layer of the at least two layers of the hierarchical taxonomy having the one less level of complexity.

In some embodiments, a non-transitory machine-readable medium includes at least one program stored thereon, the at least one program including instructions which, when executed by a processor, cause the processor to perform a method in a processor based system for comprehension-based question answering using a hierarchical taxonomy including receiving a word-based question, selecting at least one layer of the hierarchical taxonomy, wherein the hierarchical taxonomy comprises at least two layers, each of the at least two layers including respective words resulting in the at least two layers having varying levels complexity, and using a pre-trained language model, responding to the word-based question using only words associated with the selected at least one layer of the at least two layers of the hierarchical taxonomy.

In some embodiments the method further includes after receiving the word-based question, associating the word-based question with a layer of the hierarchical taxonomy, where the selecting at least one layer of the hierarchical taxonomy includes determining which layer of the at least two layers of the hierarchical taxonomy comprises a layer of complexity one level less than the layer of the hierarchical taxonomy associated with the word-based question, and where the word-based question is responded to by the pre-trained language model using only words associated with the layer of the at least two layers of the hierarchical taxonomy having the one less level of complexity.

In some alternate embodiments, a non-transitory machine-readable medium includes at least one program stored thereon, the at least one program including instructions which, when executed by a processor, cause the processor to perform a method in a processor based system for comprehension-based question answering using a hierarchical taxonomy including receiving a word-based question, associating the word-based question with a layer of the hierarchical taxonomy, wherein the hierarchical taxonomy comprises at least two layers, each of the at least two layers including respective words resulting in the at least two layers having varying levels complexity, determining a layer of the at least two layers of the hierarchical taxonomy which comprises a layer of complexity one level less than the layer of the hierarchical taxonomy associated with the word-based question, using a pre-trained language model, responding to the word-based question by using only words associated with the layer of the at least two layers of the hierarchical taxonomy having the one less level of complexity.

In some embodiments, a system for comprehension-based question answering using a hierarchical taxonomy includes a storage device and an apparatus including a processor and a memory coupled to the processor, the memory having stored therein at least one of programs or instructions. In such embodiments when the programs or instructions are executed by the processor, the system is configured to receive a word-based question, select at least one layer of the hierarchical taxonomy, wherein the hierarchical taxonomy comprises at least two layers, each of the at least two layers including respective words resulting in the at least two layers having varying levels complexity, and using a pre-trained language model, respond to the word-based question using only words associated with the selected at least one layer of the at least two layers of the hierarchical taxonomy.

In some embodiments, the system is further configured to, after receiving the word-based question, associate the word-based question with a layer of the hierarchical taxonomy, where the selecting at least one layer of the hierarchical taxonomy includes determining which layer of the at least two layers of the hierarchical taxonomy comprises a layer of complexity one level less than the layer of the hierarchical taxonomy associated with the word-based question, where the word-based question is responded to by the pre-trained language model using only words associated with the layer of the at least two layers of the hierarchical taxonomy having the one less level of complexity.

In some embodiments, an alternate system for comprehension-based question answering using a hierarchical taxonomy includes a storage device and an apparatus including a processor and a memory coupled to the processor, the memory having stored therein at least one of programs or instructions. In such embodiments when the programs or instructions are executed by the processor, the system is configured to receive a word-based question, associate the word-based question with a layer of the hierarchical taxonomy, wherein the hierarchical taxonomy comprises at least two layers, each of the at least two layers including respective words resulting in the at least two layers having varying levels complexity, determine a layer of the at least two layers of the hierarchical taxonomy which comprises a layer of complexity one level less than the layer of the hierarchical taxonomy associated with the word-based question, using a pre-trained language model, respond to the word-based question by using only words associated with the layer of the at least two layers of the hierarchical taxonomy having the one less level of complexity.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of a comprehension-based question answering system in accordance with an embodiment of the present principles.

FIG. 2 depicts an illustrative representation of an exemplary hierarchical taxonomy that can be implemented by a comprehension-based question answering system of the present principles in accordance with an embodiment of the present principles.

FIG. 3 depicts a functional diagram of an implementation of a hierarchical taxonomy in a comprehension-based question answering system in accordance with an embodiment of the present principles.

FIG. 4 depicts a Table including respective question prefixes determined for four datasets including respective, determined clarification questions and resulting question answers determined from the content in a respective one of the four databases in accordance with an embodiment of the present principles.

FIG. 5 depicts a Table including results of the application of a comprehension-based question answering system of the present principles to questions applied to the four datasets depicted in FIG. 4 in accordance with an embodiment of the present principles.

FIG. 6A depicts a flow diagram of a method for comprehension-based question answering in accordance with an embodiment of the present principles.

FIG. 6B depicts a flow diagram of an alternate method for comprehension-based question answering in accordance with an alternate embodiment of the present principles.

FIG. 7 depicts a high-level block diagram of a computing device suitable for use with embodiments of a comprehension-based question answering system in accordance with the present principles.

FIG. 8 depicts a high-level block diagram of a network in which embodiments of a comprehension-based question answering system in accordance with the present principles, can be applied.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for comprehension-based question answering implementing a hierarchical knowledge taxonomy. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to a specific hierarchical knowledge representation and associated words and phrases, such teachings should not be considered limiting. Embodiments in accordance with the present principles can function with substantially any words and phrases and can include other, not shown, hierarchical taxonomies.

Embodiments of the present principles can be applied to a number of different domains that utilize word-based comprehension, such as semantic content retrieval, automatic document summarization, multimodal human computer interaction, and the like.

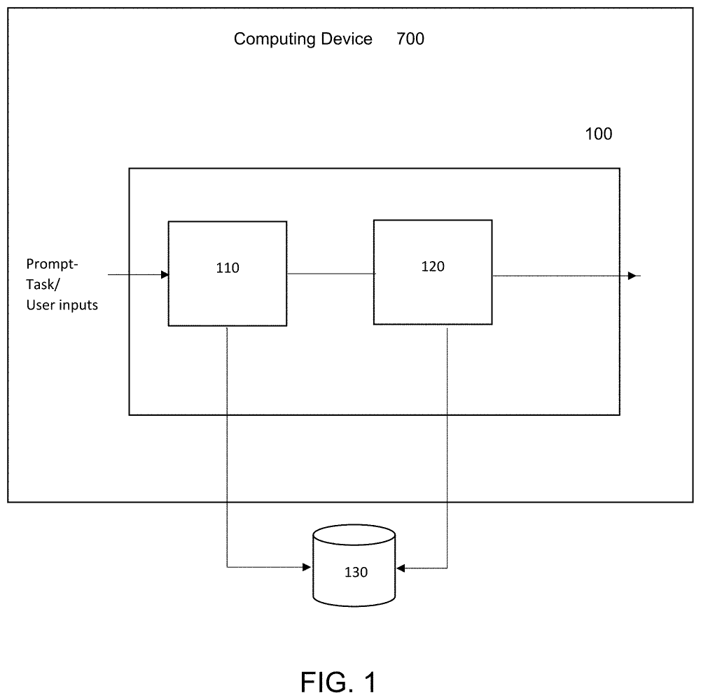

FIG. 1 depicts a high-level block diagram of a comprehension-based question answering system 100 in accordance with an embodiment of the present principles. The comprehension-based question answering system 100 of FIG. 1 illustratively comprises a prompt/task ranking module 110, a question answering module 120, and an optional storage device 130.

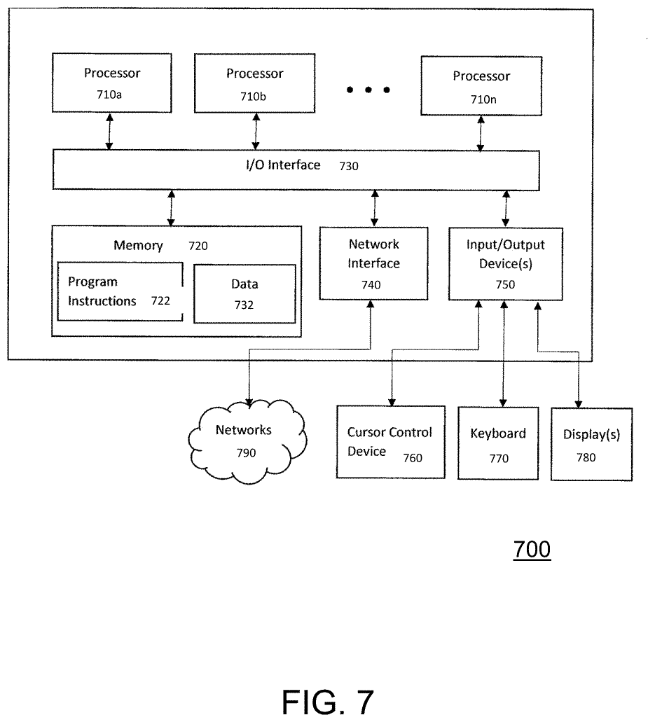

As further depicted in FIG. 1, embodiments of a comprehension-based question answering system of the present principles, such as the comprehension-based question answering system 100 of FIG. 1, can be implemented via a computing device 700 in accordance with the present principles (described in greater detail below with reference to FIG. 7).

As depicted in FIG. 1, a comprehension-based question answering system of the present principles, such as the comprehension-based question answering system 100 of FIG. 1, can receive a prompt/task intended to be answered using content (e.g., datasets) accessible to the comprehension-based question answering system 100, such as content stored in the optional storage device 130 and/or content associated with a language model. In some embodiments, the prompt/task received by the comprehension-based question answering system 100 can be input by a user using an input device of the computing device 700.

In the embodiment of the comprehension-based question answering system 100 of FIG. 1, the prompt/task ranking module 110 can select a hierarchical taxonomy to associate with/apply to a received prompt/task for assessing and assigning a received prompt/task to a level of the hierarchical taxonomy. In some embodiments, the prompt/task ranking module 110 can select a Bloom's taxonomy to associate with/apply to received prompts/tasks. In some embodiments, a listing of hierarchical taxonomies and associated information can be stored in a storage device (e.g., storage device 130) accessible by at least the prompt/task ranking module 110 of the comprehension-based question answering system 100 of FIG. 1.

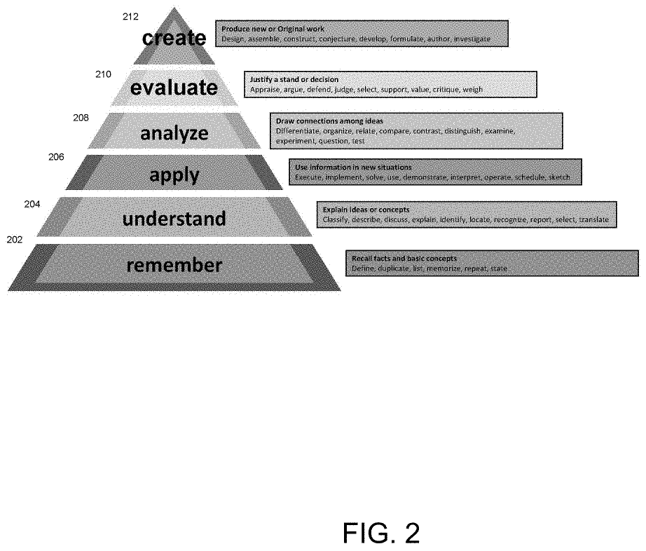

FIG. 2 depicts an illustrative representation of an exemplary hierarchical taxonomy that can be implemented by a comprehension-based question answering system of the present principles, such as the comprehension-based question answering system 100 of FIG. 1, in accordance with an embodiment of the present principles. The hierarchical taxonomy 200 of FIG. 2 is illustratively a Bloom's Hierarchy or Taxonomy. The Bloom's Hierarchy/Taxonomy provides a hierarchical taxonomy of skills which the assumption is that one progresses thru the hierarchy by gaining proficiency/mastery at each level. Each level of hierarchy can have a set of words associated with it. While Bloom's Hierarchy is described with respect to FIG. 2, it should be understood that any hierarchical taxonomy can be utilized in a system, apparatus and method for content comprehension and response in accordance with the present principles.

In the illustrative embodiment of FIG. 2, the hierarchical taxonomy comprises six (6) layers including a remember layer 202, an understanding layer 204, an application layer 206, an analysis layer 208, an evaluation layer 210, and a create layer 212, in ascending order. In the embodiment of FIG. 2, the remember layer 202 can be used to recall facts and basic concepts and can typically be associated with stem words/verbs including, but not limited to define, duplicate, list, memorize, repeat, and state. The understanding layer 204 of FIG. 2 can be used to explain ideas or concepts and can typically be associated with words/verbs including but not limited to classify, describe, discuss, explain, identify, locate, recognize, report, select, and translate. The application layer 206 can be used to use information in new situations and can typically be associated with words/verbs including but not limited to execute, implement, solve, use, demonstrate, interpret, operate, schedule, and sketch. In the embodiment of FIG. 2, the analysis layer 208 can be used to draw connections among ideas and can typically be associated with words/verbs including but not limited to differentiate, organize, relate, compare, contrast, distinguish, examine, experiment, question, and test. The evaluation layer 210 can be used to justify a stand or decision and can typically be associated with words/verbs including but not limited to appraise, argue, defend, judge, select, support, value, critique, and weigh. As further depicted in the embodiment of FIG. 2, the create layer 212 can be used to produce new or original work and can typically be associated with words/verbs including but not limited to design, assemble, construct, conjecture, develop, formulate, author, and investigate.

Although in the embodiment of FIG. 2, the hierarchical taxonomy 200 illustratively comprises six layers in ascending order of complexity/difficulty, in alternate embodiments, a hierarchical taxonomy of the present principles can include other numbers of layers having randomly arranged levels of complexity/difficulty. In accordance with the present principles, a most fundamental hierarchical taxonomy of the present principles can include at least two layers, in which the layers have different levels of complexity/difficulty. That is, as recited above each layer of a hierarchical taxonomy of the present principles have a set of words associated with the layer. The words, when applied to a respective layer, result in a level of complexity/difficulty for a respective layer resulting from what kinds of words are associated with each layer. That is, in accordance with the present principles, information/content data is stored as associated with each layer of the hierarchical taxonomy 200 of FIG. 2 according to a determined level of complexity of the information/content data.

Referring back to FIG. 1, the prompt/task ranking module 110 can associate a received prompt/task with a level in the hierarchical taxonomy. In some embodiments, the received prompt/task can include information (e.g., metadata) identifying a level in at least one hierarchical taxonomy with which a received prompt/task is associated. In such embodiments, the prompt/task ranking module 110 can use the included information to associate a received prompt/task with a level in at least one hierarchical taxonomy that can be selected by the prompt/task ranking module 110. Alternatively or in addition, in some embodiments, a user can indicate a level in at least one hierarchical taxonomy with which a received prompt/task is associated using, for example, an input device of the computing device 700. In such embodiments, the prompt/task ranking module 110 can use the information provided by the user to associate a received prompt/task with a level in at least one hierarchical taxonomy. Alternatively or in addition, in some embodiments, the optional storage device 130 can include information regarding which types of prompts/tasks are associated with which levels of at least one hierarchical taxonomy and the prompt/task ranking module 110 can implement such information included in the optional storage device 130 to associate a received prompt/task with a level in at least one hierarchical taxonomy.

In some embodiments of the present principles, a prompt/task ranking module of the present principles, such as the prompt/task ranking module 110 of FIG. 1, can implement a machine learning process/model to associate a received prompt/task with a level in at least one hierarchical taxonomy. For example, in some embodiments a machine learning (ML) algorithm can be trained using more than thousands/tens of thousands of instances of prompts/tasks. The training teaches the ML algorithm with which level of at least one hierarchical taxonomy each of the associate a received prompt/task with a level in at least one hierarchical taxonomy are associated. In some embodiments of the present principles, that association can be based on words and phrases associated with each level of a hierarchical taxonomy. Over time, the ML algorithm learns to look for specific attributes (words) in a prompt/task to determine with which level of at least one hierarchical taxonomy each of the prompts/tasks are associated. In accordance with the present principles and as described above, a ML model can be determined to apply to received prompts/tasks by, for example, a prompt/task ranking module of the present principles, to determine a level in at least one hierarchical taxonomy with which the received prompt/task is associated.

In some embodiments of the present principles, the ML algorithm can include a multi-layer neural network comprising nodes that are trained to have specific weights and biases. In some embodiments, an ML algorithm of the present principles can employ artificial intelligence techniques or machine learning techniques to analyze content of, for example, an input prompt/task. In some embodiments, in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as Se2oSeq′ Recurrent Neural Network (RNNs)/Long Short Term Memory (LSTM) networks, Convolution Neural Networks (CNNs), graph neural networks applied to the abstract syntax trees corresponding to the sequential program application, and the like. In some embodiments a supervised ML classifier could be used such as, but not limited to, Multilayer Perceptron, Random Forest, Naive Bayes, Support Vector Machine, Logistic Regression and the like.

The ML algorithm can be trained using thousands/hundreds of thousands of instances of prompt/task data each associated with a level of a hierarchical taxonomy. The training teaches the ML algorithm what level of at least one hierarchical taxonomy with which a prompt/task is associated. Over time, the ML algorithm learns to look for specific attributes in prompts/tasks data to determine with which layer of at least one hierarchical taxonomy a prompt/task is associated.

Referring back to FIG. 1, the question answering module 120 of the comprehension-based question answering system 100 can receive information regarding at least a received prompt/task, a selected taxonomy, and a level of the taxonomy with which the received prompt/task is associate from, for example, the prompt/task ranking module 110.

In accordance with the present principles, the question answering module 120 can implement a hierarchical taxonomy and a language model to provide responses to input prompts/tasks. That is, the question answering module 120 can implement layers of a hierarchical taxonomy to limit a search for responses to input prompts/tasks to words associated with at least one layer of the implemented hierarchical taxonomy. For example, the question answering module 120 can select a layer of a selected taxonomy (e.g., Bloom's Taxonomy) and limit an implemented language model to words associated with the selected layer of the taxonomy when responding to a prompt/task (described in greater detail below). Alternatively or in addition, in some embodiments the question answering module 120 can select more than one layer of a selected taxonomy (e.g., Bloom's Taxonomy) and limit an implemented language model to words associated with the selected layers of the taxonomy when responding to a prompt/task.

For example, in some embodiments the question answering module 120 can use the received information and the above-described relationships between the layers of a selected taxonomy, such as the Bloom's Taxonomy, to determine what the inventors term proximal context, to determine answers/responses to the received prompt task. That is, in some embodiments of the present principles, a comprehension-based question answering system of the present principles, such as the comprehension-based question answering system 100 of FIG. 1, determines responses/answers to received prompts/tasks by implementing, just not any data/content, but by implementing proximal data/content as arranged in an applied taxonomy. For example, in some embodiments of the present principles, the proximal context for a particular prompt/task, T, at level L is given by the tasks implicitly required by T, which are mostly at level L−1 of the taxonomy.

In some embodiments of the present principles, information regarding which levels of a taxonomy are proximate, L−1, to which other levels, L, of a taxonomy can be provided along with the taxonomy itself and such information can be stored in a storage device accessible to a comprehension-based question answering system of the present principles, such as the storage device 130 of FIG. 1. Alternatively or in addition, in some embodiments, information regarding which levels of a taxonomy are proximate to which other levels of a taxonomy can be provided by a user via, for example, an input device of the computing device 700.

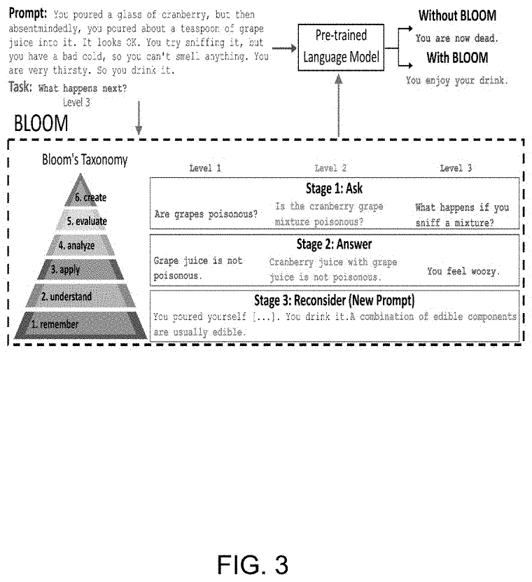

FIG. 3 depicts an example functional diagram of the operation of a comprehension-based question answering system of the present principles, such as the comprehension-based question answering system 100 of FIG. 1, including the implementation of a hierarchical taxonomy, such as the hierarchical taxonomy 200 of FIG. 2 in accordance with an embodiment of the present principles. In the functional diagram of FIG. 3 a prompt 302 indicating that a glass of cranberry juice was poured and then about a teaspoon of grape juice was poured into it is received. The prompt further indicates that you attempt to sniff the juice combination but you have a cold and can't smell and that then you drink it. An associated received task queries “what happens next”.

In accordance with the present principles, a prompt/task ranking module of the present principles, such as the prompt/task ranking module 110 of the comprehension-based question answering system 100 of FIG. 1 can associate the received prompt/task with a level of a selected taxonomy. In the embodiment of FIG. 3, the prompt/task is assigned/associated with a level 3 of the taxonomy 200 illustratively depicted in FIG. 3.

The inventors determined that in order to understand whether the cranberry-grape mixture is poisonous a question answering module of the comprehension-based question answering system of the present principles, such as the question answering module 120 of the comprehension-based question answering system 100 of FIG. 1, needs to first remember whether grape juice is poisonous. In order to apply the stored knowledge to figure out what will happen next, the comprehension-based question answering system needs to understand whether the cranberry-grape mixture is poisonous or not. In at least some embodiments of the present principles, a comprehension-based question answering system of the present principles can apply a trained language model to answer such question using the notion of proximal content as defined herein.

As such and as described above, a question answering module of the comprehension-based question answering system of the present principles, such as the question answering module 120 of the comprehension-based question answering system 100 of FIG. 1, can determine a level of the taxonomy 200 of FIG. 2 that is proximal (L−1) to the level, (L), assigned to/associated with the prompt/task received. In the embodiment of FIG. 3, the question answering module 120 determines that the proximal level (L−1) to the level, (L), assigned to/associated with the prompt/task received is level 2 of the taxonomy 200.

In accordance with the present principles, the language model, LM, of the question answering module 120 is trained to ask itself clarifying questions to generate clarifications. For example, in some embodiments, to produce clarifications, a set of question prefixes r₁, . . . rⱼ, are determined, that, in some embodiments, are designed specifically for a particular dataset. In some embodiments, at least one question prefix is determined for and associated with each level of the applied taxonomy, such as the taxonomy 200 of FIG. 2. The language model can then complete each of the question prefixes using a generator function, LM_{G}, to generate at least one respective question, Rⱼ=LM_{G}(rⱼ), per prefix. For example, in the embodiment of FIG. 3, a generated question recites “is a mixture of grape juice and cranberry juice safe to drink?” and the generated question is determined such that the question is associated with a layer of the taxonomy that has a level of complexity one level below (taxonomy level 2) a level of complexity associated with a layer of the taxonomy with which the prompt/task is associated (taxonomy level 3) (described in greater detail below).

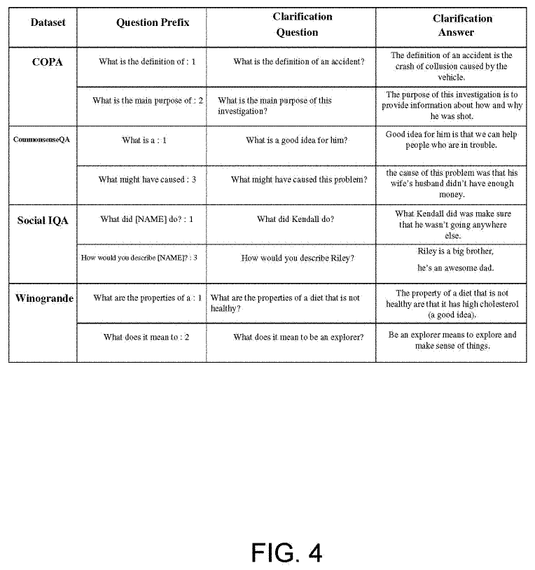

For example, FIG. 4 depicts a Table of datasets, associated clarification prefixes, clarification questions, and clarification answers in accordance with an embodiment of the present principles. In the Table of FIG. 4, a first column includes datasets illustratively including a Choice of Plausible Alternatives (COPA) dataset, a Commonsense QA dataset, a Social IQA dataset, and a Winogrande dataset. A second column of the Table of FIG. 4 illustratively depicts two respective prefixes for each dataset. Illustratively, the second column of FIG. 4 includes the respective prefixes of “what is the definition of” and what is the main purpose of” for the COPA dataset, “what is” and “what might have caused” for the Commonsense QA dataset”, “what did [NAME] do” and “how would you describe [NAME]” for the Social IQA dataset, and “what are the properties of a” and “what does it mean to” for the Winogrande dataset. In the Table of FIG. 4, the second column further includes a number associated with each prefix, which reflects a level in a taxonomy, such as Bloom's Taxonomy, with which each prefix is associated in accordance with the present principles.

The third column of the Table of FIG. 4 contains clarification questions, illustratively one clarification question for each of the prefixes. In some embodiments, the clarification questions are determined by the language model, which completes each of the prefixes using a generator function, LM_{G}, to generate one question, Rⱼ32 LM_{G}(rⱼ), per prefix.

The fourth column of the Table of FIG. 4 contains answers to the clarification questions. That is, the language model is used to answer each of the questions, prompted with an answer prefix, bⱼ, corresponding to a question prefix, rⱼ. The results are the clarifications, cⱼ=LM_{G}([Rⱼ, bⱼ]).

In accordance with the present principles, when a prompt/task is received, the question answering module 120 of the comprehension-based question answering system 100 of FIG. 1, knowing a level of a selected taxonomy with which the prompt/task is associated, only enables the learning model access to proximate content, as described above. That is, the level, L, of a prompt/task is considered and only proximal clarifications of level L−1 are allowed to be considered by the language model when providing a response/answer to the prompt/task. For example, as depicted in the Table of FIG. 4, in accordance with the present principles, each question prefix is associated with a level, L−1, of the taxonomy (e.g., Bloom's Taxonomy) having been selected by, for example a prompt/task ranking module of a comprehension-based question answering system of the present principles, such as the prompt/task ranking module 120 of the comprehension-based question answering system 100 of FIG. 1. In accordance with the present principles, the question answering module of the comprehension-based question answering system of the present principles limits the language model's choice of clarifications to a set of clarifications, C_{L-1}, of level L−1. The result is a final choice by the language model for a respective level, o*_{L}=argmaxₒ max_{j∈C}_{_{L}} LM(T_{j,o}).

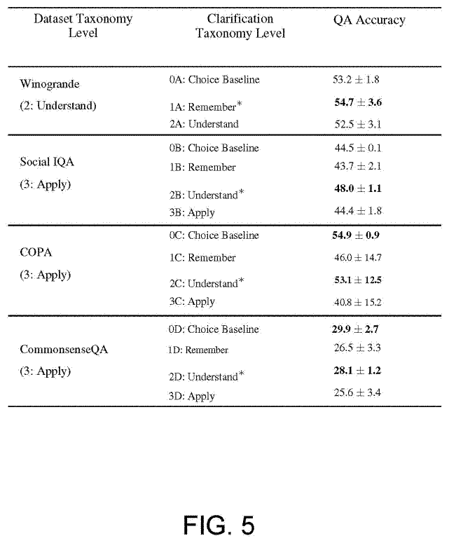

The functionality of an embodiment of a comprehension-based question answering system of the present principles, such as the comprehension-based question answering system 100 of FIG. 1, was evaluated using the four datasets listed in the Table depicted in FIG. 4. For example, FIG. 5 depicts a Table including results of the application of a comprehension-based question answering system of the present principles to prompts/tasks to be answered by content of the four datasets depicted in FIG. 4. In the Table of FIG. 5, a first column lists the four datasets and a respective level of a taxonomy (e.g., a Bloom's Taxonomy) associated with a prompt/task to be answered using each of the datasets. A second/middle column of the Table of FIG. 5 lists at least three respective levels of the taxonomy (illustratively Bloom's Taxonomy) each representative of level of classification (e.g., prefix question/question) implemented to attempt to answer the prompt/task. A third/last column of the Table of FIG. 5 depicts a respective answer accuracy level for each of the at least three respective levels of the taxonomy for each of the four datasets. During the evaluation, in order to fairly compare performance across different levels of clarifications, only examples in which an applied language model was able to generate at least one clarification from each level of the taxonomy was considered. In addition, only clarifications which had no overlapping words with the context were kept. In the Table of FIG. 5, the proximal clarification level for each dataset is marked by an asterisk, *. As depicted in the Table of FIG. 5, the inventors further included a Choice Baseline that enabled the language model to choose any level of clarification for attempting to answer a respective question. The results of the Table of FIG. 5 demonstrate that the language model would have difficulty choosing proximal clarifications on its own for answering a respective question.

As depicted in the Table of FIG. 5, for all cases, when answering a question, implementing proximal clarifications having an associated taxonomy level one level less in complexity than a respective prompt/task in a language model, in accordance with the present principles, provides better results than using clarifications of a higher or lower level. For example, for the Winogrande dataset, which has an associated clarification prefix/question having a taxonomy level of 2, a question answering accuracy of row 1A is greater than 2A. In the Table of FIG. 5, for the Social IQA dataset, the COPA dataset, and the Commonsense QA dataset, each having an associated clarification prefix/question taxonomy level of 3, the proximal (level 2) clarifications outperform level 1 clarifications. As depicted by the information in the Table of FIG. 5, overall, the implementation of proximal context by a language model in accordance with the present principles, has most impact on increased question answering accuracy.

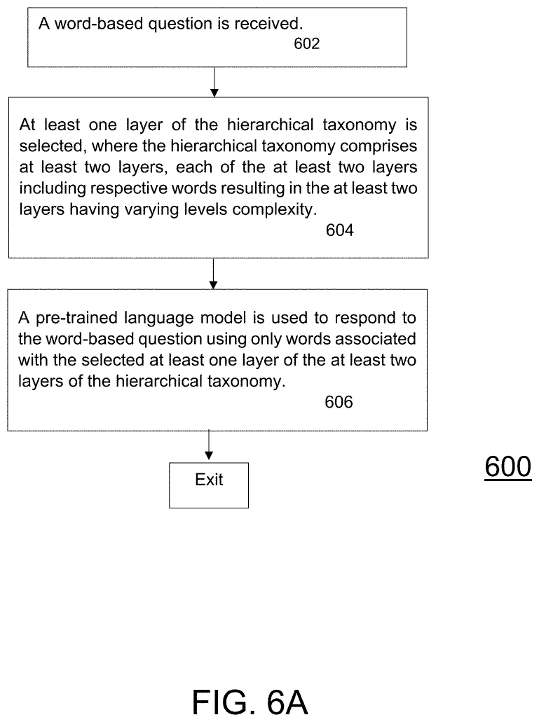

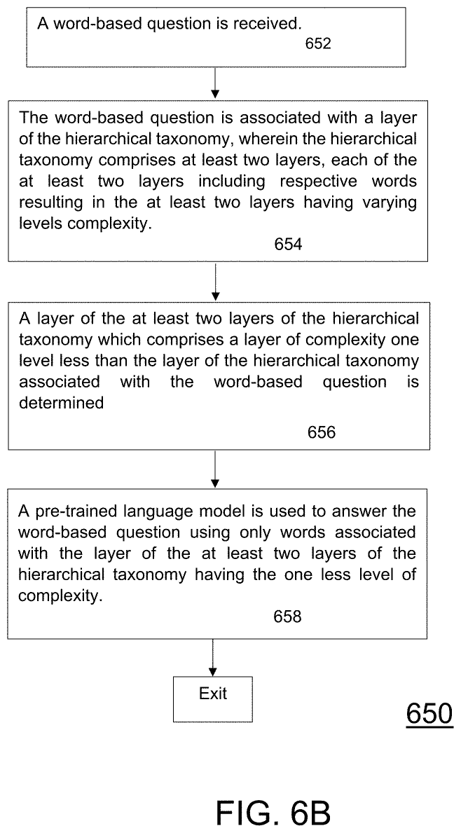

FIG. 6A depicts a flow diagram of a first method 600 for comprehension-based question answering in accordance with an embodiment of the present principles. The method 600 can begin at 602 during which a word-based question is received. The method 600 can proceed to 604.

At 604, at least one layer of the hierarchical taxonomy is selected, wherein the hierarchical taxonomy comprises at least two layers, each of the at least two layers including respective words resulting in the at least two layers having varying levels complexity. The method 600 can proceed to 606.

At 606, a pre-trained language model is used to respond to the word-based question using only words associated with the selected at least one layer of the at least two layers of the hierarchical taxonomy. The method 600 can then be exited.

FIG. 6B depicts a flow diagram of a method 650 for comprehension-based question answering in accordance with an alternate embodiment of the present principles. The method 650 can begin at 652 during which a word-based question is received. The method 650 can proceed to 654.

At 654, the word-based question is associated with a layer of the hierarchical taxonomy, wherein the hierarchical taxonomy comprises at least two layers, each of the at least two layers including respective words resulting in the at least two layers having varying levels complexity. The method 650 can proceed to 656.

At 656, a layer of the at least two layers of the hierarchical taxonomy which comprises a layer of complexity one level less than the layer of the hierarchical taxonomy associated with the word-based question is determined. The method 650 can proceed to 658.

At 658, a pre-trained language model is used to answer/respond to the word-based question using only words associated with the layer of the at least two layers of the hierarchical taxonomy having the one less level of complexity. The method 650 can then be exited.

As depicted in FIG. 1, embodiments of a comprehension-based question answering system of the present principles, such as the comprehension-based question answering system 100 of FIG. 1, can be implemented in a computing device 700 in accordance with the present principles. That is, in some embodiments, questions intended to be answered using content data and the like can be communicated to components of the comprehension-based question answering system 100 of FIG. 1 using the computing device 700 via, for example, any input/output means associated with the computing device 700. Information associated with a comprehension-based question answering system in accordance with the present principles can be presented to a user using an output device of the computing device 700, such as a display, a printer or any other form of output device.

For example, FIG. 7 depicts a high-level block diagram of a computing device 700 suitable for use with embodiments of a comprehension-based question answering system in accordance with the present principles such as the comprehension-based question answering system 100 of FIG. 1. In some embodiments, the computing device 700 can be configured to implement methods of the present principles as processor-executable executable program instructions 722 (e.g., program instructions executable by processor(s) 710) in various embodiments.

In the embodiment of FIG. 7, the computing device 700 includes one or more processors 710a-710n coupled to a system memory 720 via an input/output (I/O) interface 730. The computing device 700 further includes a network interface 740 coupled to I/O interface 730, and one or more input/output devices 750, such as cursor control device 760, keyboard 770, and display(s) 780. In various embodiments, a user interface can be generated and displayed on display 780. In some cases, it is contemplated that embodiments can be implemented using a single instance of computing device 700, while in other embodiments multiple such systems, or multiple nodes making up the computing device 700, can be configured to host different portions or instances of various embodiments. For example, in one embodiment some elements can be implemented via one or more nodes of the computing device 700 that are distinct from those nodes implementing other elements. In another example, multiple nodes may implement the computing device 700 in a distributed manner.

In different embodiments, the computing device 700 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 700 can be a uniprocessor system including one processor 710, or a multiprocessor system including several processors 710 (e.g., two, four, eight, or another suitable number). Processors 710 can be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 can be configured to store program instructions 722 and/or data 732 accessible by processor 710. In various embodiments, system memory 720 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 720. In other embodiments, program instructions and/or data can be received, sent or stored upon different types of computer-accessible media or on similar media separate from system memory 620 or computing device 700.

In one embodiment, I/O interface 730 can be configured to coordinate I/O traffic between processor 710, system memory 720, and any peripheral devices in the device, including network interface 740 or other peripheral interfaces, such as input/output devices 750. In some embodiments, I/O interface 730 can perform any necessary protocol, timing or other data transformations to convert data signals from one component (e.g., system memory 720) into a format suitable for use by another component (e.g., processor 710). In some embodiments, I/O interface 730 can include support for devices attached through various types of peripheral buses, such as a variant of the Peripheral Component Interconnect (PCI) bus standard or the Universal Serial Bus (USB) standard, for example. In some embodiments, the function of I/O interface 730 can be split into two or more separate components, such as a north bridge and a south bridge, for example. Also, in some embodiments some or all of the functionality of I/O interface 730, such as an interface to system memory 720, can be incorporated directly into processor 710.

Network interface 740 can be configured to allow data to be exchanged between the computing device 700 and other devices attached to a network (e.g., network 790), such as one or more external systems or between nodes of the computing device 700. In various embodiments, network 790 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 750 can, in some embodiments, include one or more display terminals, keyboards, keypads, touchpads, scanning devices, voice or optical recognition devices, or any other devices suitable for entering or accessing data by one or more computer systems. Multiple input/output devices 750 can be present in computer system or can be distributed on various nodes of the computing device 700. In some embodiments, similar input/output devices can be separate from the computing device 700 and can interact with one or more nodes of the computing device 700 through a wired or wireless connection, such as over network interface 740.

Those skilled in the art will appreciate that the computing device 700 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 700 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 700 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 600 can further include a web browser.

Although the computing device 700 is depicted as a general purpose computer, the computing device 700 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

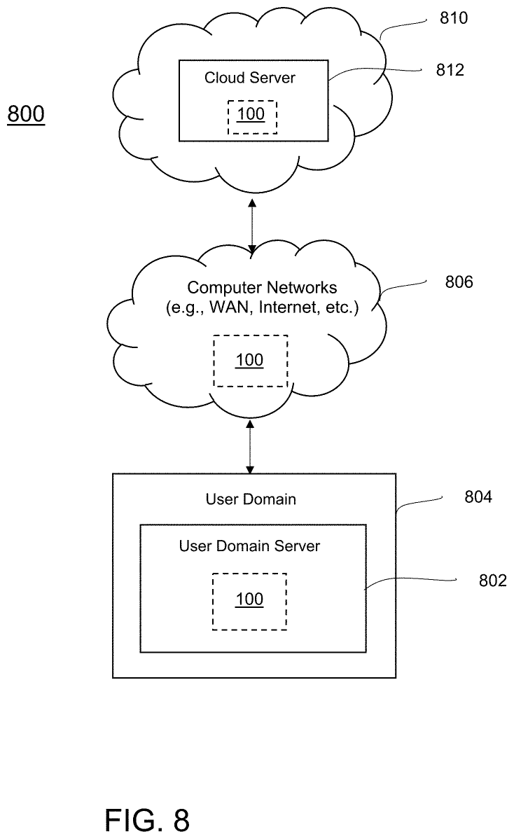

FIG. 8 depicts a high-level block diagram of a network in which embodiments of a comprehension-based question answering system in accordance with the present principles, such as the comprehension-based question answering system 100 of FIG. 1, can be applied. The network environment 800 of FIG. 8 illustratively comprises a user domain 802 including a user domain server/computing device 804. The network environment 800 of FIG. 8 further comprises computer networks 806, and a cloud environment 810 including a cloud server/computing device 812.

In the network environment 800 of FIG. 8, a system for comprehension-based question answering in accordance with the present principles, such as the system 100 of FIG. 1, can be included in at least one of the user domain server/computing device 804, the computer networks 806, and the cloud server/computing device 812. That is, in some embodiments, a user can use a local server/computing device (e.g., the user domain server/computing device 804) to provide responses to questions in accordance with the present principles.

In some embodiments, a user can implement a system for comprehension-based question answering in the computer networks 806 to provide comprehension-based question answering in accordance with the present principles. Alternatively or in addition, in some embodiments, a user can implement a system for comprehension-based question answering in the cloud server/computing device 812 of the cloud environment 810 to provide comprehension-based question answering in accordance with the present principles. For example, in some embodiments it can be advantageous to perform processing functions of the present principles in the cloud environment 810 to take advantage of the processing capabilities and storage capabilities of the cloud environment 810. In some embodiments in accordance with the present principles, a system for comprehension-based question answering can be located in a single and/ or multiple locations/servers/computers to perform all or portions of the herein described functionalities of a system in accordance with the present principles. For example, in some embodiments some components of a comprehension-based question answering system of the present principles can be located in one or more than one of the a user domain 802, the computer network environment 806, and the cloud environment 810 while other components of the present principles can be located in at least one of the user domain 802, the computer network environment 806, and the cloud environment 810 for providing the functions described above either locally or remotely.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 700 can be transmitted to the computing device 700 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for comprehension-based question answering using a hierarchical taxonomy, comprising:
receiving a word-based question;
selecting at least one layer of the hierarchical taxonomy, wherein the hierarchical taxonomy comprises at least two layers, each of the at least two layers including respective words resulting in the at least two layers having varying levels complexity: and
using a pre-trained language model, responding to the word-based question using only words associated with the selected at least one layer of the at least two layers of the hierarchical taxonomy.

2. The method of claim 1, further comprising:
after receiving the word-based question, associating the word-based question with a layer of the hierarchical taxonomy;
wherein the selecting at least one layer of the hierarchical taxonomy includes determining which layer of the at least two layers of the hierarchical taxonomy comprises a layer of complexity one level less than the layer of the hierarchical taxonomy associated with the word-based question; and
wherein, the word-based question is responded to by the pre-trained language model using only words associated with the layer of the at least two layers of the hierarchical taxonomy having the one less level of complexity.

3. The method of claim 2, wherein the associating is performed by a user via a graphical user input.

4. The method of claim 2, wherein the associating is performed using a machine learning process.

5. The method of claim 2, wherein the associating is performed using stored information associating questions with respective layers of at least one hierarchical taxonomy.

6. The method of claim 2, wherein the determining is performed using information provided by a user.

7. The method of claim 2, wherein the determining is perfumed using information provided with the hierarchical taxonomy.

8. A non-transitory machine-readable medium having stored thereon at least one program, the at least one program including instructions which, when executed by a processor, cause the processor to perform a method in a processor based system for comprehension-based question answering using a hierarchical taxonomy, comprising:
receiving a word-based question;
selecting at least one layer of the hierarchical taxonomy, wherein the hierarchical taxonomy comprises at least two layers, each of the at least two layers including respective words resulting in the at least two layers having varying levels complexity: and
using a pre-trained language model, responding to the word-based question using only words associated with the selected at least one layer of the at least two layers of the hierarchical taxonomy.

9. The non-transitory machine-readable medium of claim 8, wherein the method further comprises:
after receiving the word-based question, associating the word-based question with a layer of the hierarchical taxonomy;
wherein the selecting at least one layer of the hierarchical taxonomy includes determining which layer of the at least two layers of the hierarchical taxonomy comprises a layer of complexity one level less than the layer of the hierarchical taxonomy associated with the word-based question; and
wherein, the word-based question is responded to by the pre-trained language model using only words associated with the layer of the at least two layers of the hierarchical taxonomy having the one less level of complexity.

10. The non-transitory machine-readable medium of claim 9, wherein the associating is performed by a user via a graphical user input.

11. The non-transitory machine-readable medium of claim 9, wherein the associating is performed using a machine learning process.

12. The non-transitory machine-readable medium of claim 9, wherein the associating is performed using stored information associating questions with respective layers of at least one hierarchical taxonomy.

13. The non-transitory machine-readable medium of claim 9, wherein the determining is performed using information provided by a user.

14. The non-transitory machine-readable medium of claim 9, wherein the determining is perfumed using information provided with the hierarchical taxonomy.

15. A system for comprehension-based question answering using a hierarchical taxonomy, comprising:
a storage device; and
an apparatus; comprising
a processor; and
a memory coupled to the processor, the memory having stored therein at least one of programs or instructions executable by the processor to configure the system to:
receive a word-based question;
select at least one layer of the hierarchical taxonomy, wherein the hierarchical taxonomy comprises at least two layers, each of the at least two layers including respective words resulting in the at least two layers having varying levels complexity: and
using a pre-trained language model, respond to the word-based question using only words associated with the selected at least one layer of the at least two layers of the hierarchical taxonomy.

16. The system of claim 15, wherein the system is further configured to:
after receiving the word-based question, associate the word-based question with a layer of the hierarchical taxonomy;
wherein the selecting at least one layer of the hierarchical taxonomy includes determining which layer of the at least two layers of the hierarchical taxonomy comprises a layer of complexity one level less than the layer of the hierarchical taxonomy associated with the word-based question; and
wherein, the word-based question is responded to by the pre-trained language model using only words associated with the layer of the at least two layers of the hierarchical taxonomy having the one less level of complexity.

17. The system of claim 16, further comprising a graphical user input and wherein the associating is performed by a user via the graphical user input.

18. The system of claim 16, wherein the associating is performed using a machine learning process.

19. The system of claim 16, wherein the associating is performed using information stored in the storage device associating questions with respective layers of at least one hierarchical taxonomy.

20. The system of claim 16, wherein the determining is performed using at least one of information provided by a user or information provided with the hierarchical taxonomy.
